(19) United States
(12) Patent Application Publication
(10) Pub. No.: US 2003/0212621 A1
(43) Pub. Date: Nov. 13, 2003

(54) System and method for evaluating securities and portfolios thereof

(75) Inventors: John Poulter, Toronto (CA); Neil Gilday, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Portfolio Aid Inc., Toronto (CA)

(21) Appl. No.: 10/434,170

(22) Filed: May 9, 2003

Related U.S. Application Data
(60) Provisional application No. 60/379,017, filed on May 10, 2002.

(51) Int. Cl. G06F 17/60

(52) U.S. Cl. 705/36

(57) ABSTRACT

A computer-based system and method for evaluating securities of a company of interest in which quality and value composite measures are computed based on quality and value assessment measures for each company of a group of companies respectively. Output to the user based on the quality and value composite measures for the company of interest is generated, whereby the output reflects a valuation of the company of interest relative to other companies in the group.

### FIELD OF THE INVENTION

The present invention relates generally to the valuation of financial instruments, and more particularly to a system and method for evaluating securities issued by companies of interest.

### BACKGROUND OF THE INVENTION

A number of software systems designed to evaluate securities issued by companies that may be of interest to a user exist in the prior art. These prior art systems assist users, to varying degrees, in assessing the quality, value, and risk of the companies in which they may wish to invest. Such systems may be used by, for example, portfolio managers, advisors and investors to build investment strategies.

In order for the software systems to be practically useful, they must generally be designed to efficiently collect, organize, and evaluate vast amounts of financial and other types of data that are retrieved from multiple data providers and from other data sources. The data may then be processed according to a specific model or methodology to evaluate companies of interest, and to determine whether it would be desirable to buy or sell securities issued by those companies.

For instance, U.S. Pat. No. 6,317,726 describes an example of a method of implementing investment strategies to facilitate the selection of corporate stocks for investment. A number of value factors are considered in the assessment of strategies, which may include price-to-earnings ratios, price-to-book ratios, cash flow ratios, price-to-sales ratios, and dividend yields. Strategies can then be evaluated using the Sharpe ratio.

U.S. Pat. No. 6,211,880 discloses an apparatus for displaying trends in the prices of financial instruments such as stocks. A display is dedicated to a specific sector of the market and appears rectangular with individual boxes, where each box represents an individual stock. A color is assigned to each box, representing the degree of fractional deviation of the most recent trading price of the corresponding stock from an assigned selected reference value, such as the price at the end of a previous trading session, for example.

U.S. Pat. No. 5,946,666 discloses another example of an apparatus for monitoring financial securities. Financial market changes are monitored by the collection and organization of multiple data items relating to a market segment. In particular, “security index values” provide the basis for monitoring a security of interest (e.g. a stock). Such security index values may include dividend values, yields, price-to-earnings ratios, numbers of shares traded on a previous day, and high and low stock prices for a given day, for example. The measured value of each security index value is transformed to yield an appropriate “deviation indicator”, which represents the level of performance associated with the security index value when compared to a “baseline”. Values used as the baseline may include, the opening or closing price, the year-to-date average price, or the year-to-date high or low price of the security, for example. However, the deviation indicators and the baseline values described in U.S. Pat. No. 5,946,666 are not derived from measures or attributes associated with each security of a specific group of interest.

### SUMMARY OF THE INVENTION

The present invention relates generally to the valuation of financial instruments, and more particularly to a system and method for evaluating securities issued by companies of interest.

In one aspect of the present invention, there is provided a method of evaluating a security issued by a company of interest, the method to be performed by a computer, wherein the method comprises the following steps:

a) computing a value for one or more quality assessment measures for each company of a group of companies;

b) computing a value for one or more value assessment measures for each company of the group;

c) for each quality assessment measure, computing a first mean and a first standard deviation of the values therefor across all companies in the group and computing a relative quality score associated therewith for the company of interest, the relative quality score being a function of the first mean and the first standard deviation;

d) for each value assessment measure, computing a second mean and a second standard deviation of the values therefor across all companies in the group and computing a relative value score associated therewith for the company of interest, the relative value score being a function of the second mean and the second standard deviation;

e) computing a quality composite measure for the company of interest, wherein the quality composite measure is a function of the relative quality scores associated with at least one quality assessment measure;

f) computing a value composite measure for the company of interest, wherein the value composite measure is a function of the relative value scores associated with at least one value assessment measure; and

g) generating output to the user based on the quality and value composite measures for the company of interest, whereby the output reflects a valuation of the company of interest relative to other companies in the group.

In another aspect of the present invention, there is provided a security evaluation system for evaluating securities, the system comprising a system database for storing values of a plurality of quality assessment measures and value assessment measures for each company of a group of companies, a user interface for receiving input from a user and providing output to the user, and a processing engine connected to the system database and the user interface, wherein the processing engine is programmed to perform the steps of:

a) computing a value for one or more quality assessment measures for each company of a group of companies;

b) computing a value for one or more value assessment measures for each company of the group;

c) for each quality assessment measure, computing a first mean and a first standard deviation of the values therefor across all companies in the group and computing a relative quality score associated therewith for the company of interest, the relative quality score being a function of the first mean and the first standard deviation;

d) for each value assessment measure, computing a second mean and a second standard deviation of the values therefor across all companies in the group and computing a relative value score associated therewith for the company of interest, the relative value score being a function of the second mean and the second standard deviation;

e) computing a quality composite measure for the company of interest, wherein the quality composite measure is a function of the relative quality scores associated with at least one quality assessment measure;

f) computing a value composite measure for the company of interest, wherein the value composite measure is a function of the relative value scores associated with at least one value assessment measure; and

g) generating output to the user based on the quality and value composite measures for the company of interest, whereby the output reflects a valuation of the company of interest relative to other companies in the group.

In another aspect of the invention, the steps performed in a method of evaluating a security issued by a company of interest in an embodiment of the present invention may be embodied in a plurality of instructions stored on a computer-readable medium.

The present invention is generally directed to a computer-based security evaluation system and method that facilitates the harnessing of large amounts of financial data on a timely basis. The present invention permits the comparison of securities issued by a company of interest to those issued by other companies in a peer group, which may comprise companies in the same industry sector, for example. This is achieved by calculating various assessment measures or characteristics for these companies (e.g. quality and value characteristics), and also composite measures or scores for each company that reflect how securities issued by that company are to be evaluated relative to those of other companies in the same peer group.

At least some of the calculations performed are based on standard statistical measures. The statistical mean of values of a particular assessment measure associated with all companies in a peer group serves as a benchmark to which a value of the assessment measure for a specific company of interest can be compared. Furthermore, the standard deviation of values of the particular assessment measure associated with all companies in the peer group is used to quantify the extent to which the value of the assessment measure for the specific company of interest deviates from the benchmark.

Composite measures calculated for companies in the peer group may then be used to obtain a target price for a security issued by the specific company of interest. Graphical output that illustrates the value of the composite measures associated with the specific company relative to other companies in the peer group and/or relative to other companies for which securities are held in a user-defined portfolio may be generated.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic diagram illustrating components of a security evaluation system in an embodiment of the present invention;

FIG. 2 is a flowchart illustrating the steps in a method of evaluating a security issued by a company of interest in an embodiment of the present invention;

FIG. 3 is a sample table illustrating the values obtained in calculating a quality composite measure for an example company;

FIG. 4 is a sample table illustrating the values obtained in calculating a value composite measure for the example company;

FIGS. 5 and 6 are sample charts illustrating how an identifier for the example company is placed on a Quality-Value Chart;

FIG. 7 illustrates a sample chart associated with a first example portfolio, which may suggest an underlying value investment strategy;

FIG. 8 illustrates a sample chart associated with a second example portfolio, which may suggest an underlying growth investment strategy;

FIG. 9 is a table illustrating how a target price is calculated for an example company; and

FIG. 10 is a sample report generated by the security evaluation system in an embodiment of the present invention.

### DETAILED DESCRIPTION OF THE INVENTION

The present invention relates generally to the valuation of financial instruments, and more particularly to a system and method for evaluating securities issued by companies of interest.

While the invention has been described herein, by way of example, with reference to equities in some embodiments, the present invention may be applied to other securities. A “security” of a company can be more generally defined as any financial instrument issued by the company.

A “portfolio” may be broadly defined as an ownership grouping of securities, such as a retail account, a mutual fund or group of mutual funds, and indices (e.g. Standard & Poor's S&P 500 index), for example.

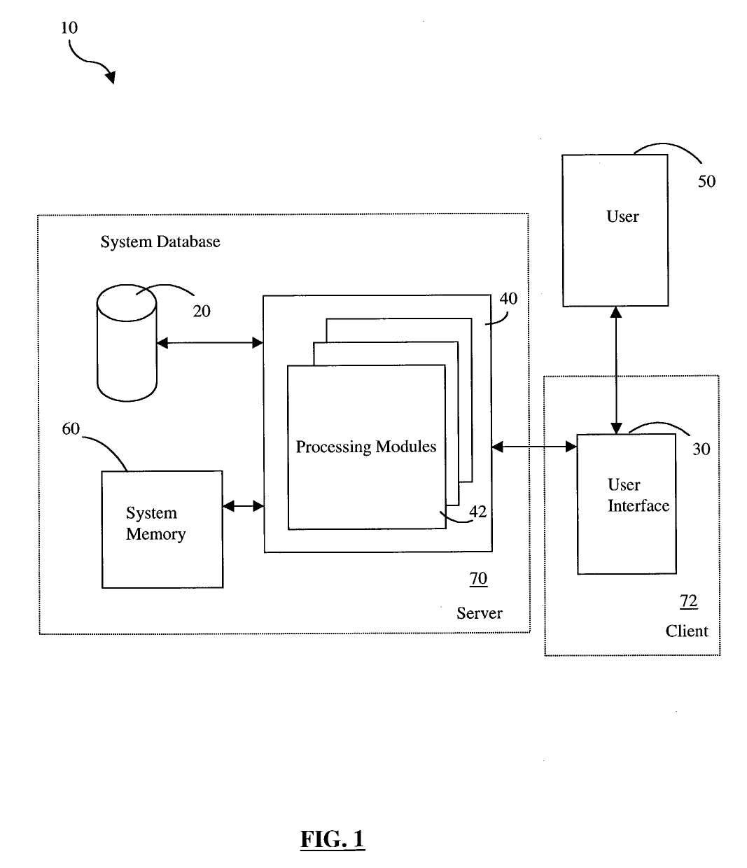

Referring to FIG. 1, a schematic diagram illustrating components of a security evaluation system in an embodiment of the present invention is shown generally as 10. Security evaluation system 10 comprises a system database 20, a user interface 30, and a processing engine 40.

In this embodiment of the invention, system database 20 is used to store data that is used and generated by processing engine 40. For example, system database 20 may store financial data or other data obtained by processing engine 40 from one or more external data providers and/or other data sources [not shown]. Such external data sources may include financial databases such as Standard and Poor's COMPUSTAT® and Global Vantage™ databases, for example.

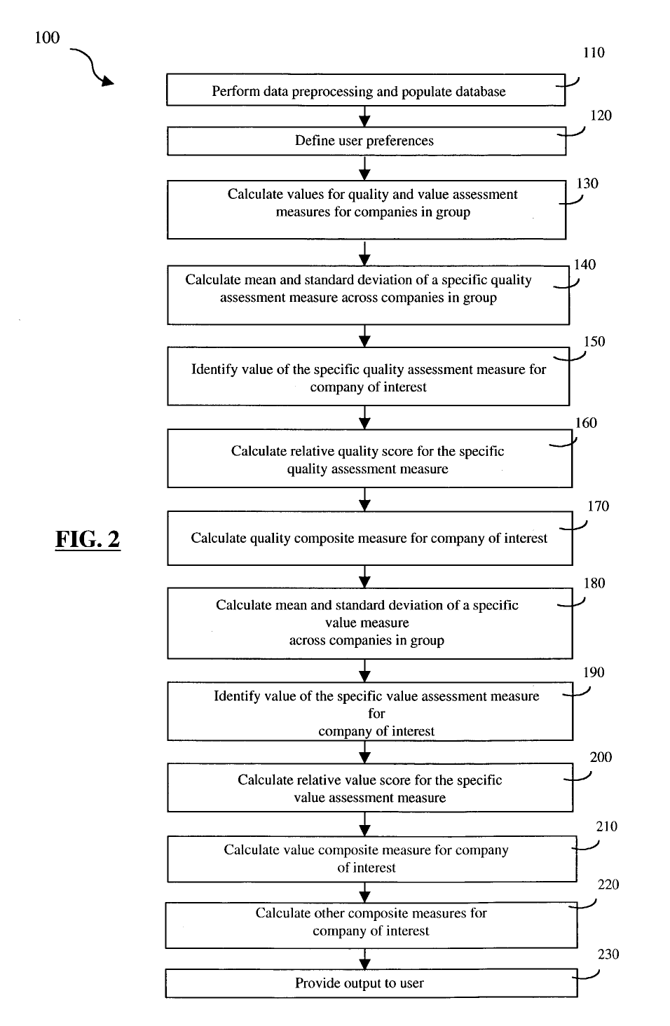

System database 20 may also store the values of simplified data items calculated by processing engine 40. The calculation of simplified data items is described in further detail below with reference to FIG. 2. Other data generated by processing engine 40 including the values of assessment measures and fundamental composite measures (described in further detail below), can also be stored in system database 20.

Processing engine 40 is comprised of one or more processing modules 42 programmed to implement a method of evaluating a security of a company of interest in an embodiment of the present invention, using information received from a user 50 through user interface 30. Data used and generated by processing engine 40 may be stored in system database 20. Processing engine 40 may also be connected to a system memory 60 for temporary storage of data used in calculations or other tasks performed by processing engine 40. Processing engine 40 may be adapted to update specific data items in system database 20 (e.g. by obtaining more current data from an external database) at the request of a user, or at a user-defined interval (e.g. at the end of every business day). Processing engine 40 may also provide output to user 50 using user interface 30.

In one embodiment of the invention, system database 20, processing engine 40 and system memory 60 reside on a server 70, while user interface 30 resides on a client computing device 72, although it will be understood by persons skilled in the art that other configurations of the security evaluation system 10 are possible in variant embodiments of the present invention.

In use, security evaluation system 10 facilitates the organization and evaluation of large amounts of financial information that may be made available from a variety of data providers, including for example, company filings on the Electronic Data Gathering, Analysis, and Retrieval (EDGAR) system and the System for Electronic Document Analysis and Retrieval (SEDAR), analyst forecast services, pricing feeds from security exchanges, and other data sources.

In accordance with an embodiment of the present invention, security evaluation system 10 is adapted to produce the following components:

(i) simplified data items;

(ii) assessment measures (also referred to herein as “fundamentals”);

(iii) fundamental composite measures (also referred to herein as “fundamental composites”)

(iv) target prices;

(v) reports;

(vi) charts; and

(vii) portfolios.

These components will be described in further detail below with reference to the remaining Figures.

The fundamental composite measures calculated by security evaluation system 10 relate to one or more sets of companies in a specific “peer group”, which is typically user-defined or user-selected. Typically, companies in a peer group are related to one another in some manner. Most typically, companies are categorized into different peer groups based on industry sector. Whether or not a company belongs in a specific peer group based on a particular industry sector, can be determined by an investment manager or other user of security evaluation system 10, or defined using a proprietary or known peer grouping or sectoring scheme (e.g. groups based on Standard & Poor's Global Industry Classification (GIC) codes), for example.

Companies can also be grouped based on securities issued by those companies contained in user-defined portfolios. Portfolios can be constructed in any manner as desired, and need not be comprised of securities issued by companies belonging to a single industry sector. Fundamental composite measures calculated by security evaluation system 10 and output provided security evaluation system 10 based on a user-defined portfolio may be used to evaluate securities in the portfolio, and also to determine whether the portfolio reflects a specific investment style (e.g. value investment strategy, growth investment strategy), for example. It will be understood by persons skilled in the art that other user-defined groups may be employed in implementations of the present invention.

To calculate fundamental composite measures for a set of companies in a peer group, security evaluation system 10 begins by building a set of simplified data items. As will be explained in further detail with reference to FIG. 2, this is effected through a process of normalization and cleaning, in which thousands of data items for a company retrieved from external data sources (e.g. publicly available financial statements) are reduced to a smaller set of simplified data items, which can be more efficiently stored in system database 20. These simplified data items can then be used to produce a number of assessment measures or fundamentals, which may be user-defined, and which are used to evaluate the securities of companies in the peer group. Values for each of these assessment measures are calculated for each of these companies, and this information may be provided to users in the form of a report. These values also serve as the foundation for calculating a number of fundamental composite measures or fundamental composites. Fundamental composite measures can be calculated for each company in the peer group, and this information can be used, for example, to plot charts that illustrate the values of the fundamental composite measures associated with one company relative to those of others in the peer group, and to calculate target prices for securities issued by one or more companies of interest. These target prices may be used as a basis for a “buy” or “sell” recommendation for securities issued by one or more companies in the peer group.

In one implementation of an embodiment of the present invention developed by the assignee of the present invention, security evaluation system 10 is a Quality-Value system (also referred to herein as “Q.V. System”). The Q.V. System is based on the production of fundamentals and fundamental composites that reflect the quality of a company in a user-defined group (e.g. Quality fundamentals and Quality composites) and the value of a company in the user-defined group (e.g. Value fundamentals and Value composites). The Q.V. System is also adapted to generate other assessment measures and composite measures, such as risk composite measures and market capitalization measures, for example.

Simple charts may be produced by the Q.V. System that serve as simple visual representations of fundamental quality and value for a majority of companies issuing securities listed on public equity security exchanges in North America and around the world. These charts are represented in a graphical format and are presented on an industry basis. The positioning of an identifier of a company on the graph is a depiction of the relative value and the relative quality of that company. By locating the identifier of a company on the chart where identifiers of other companies are displayed, it is possible for a user to determine whether the company is of higher quality and of higher value compared to its industry peers.

Information provided by the Q.V. System can be used to generate target prices for securities issued by companies of interest, where each target price is a peer-relative price of the corresponding security based on an industry arbitrage between quality and value. Put another way, the manner in which target prices are calculated is based on the premise that a company of higher quality should be of higher value, thus costing more. Accordingly, the Q.V. System may be used by investment managers and advisors to evaluate specific companies that may be investment candidates.

These and other features of the present invention will now be explained in further detail with reference to FIG. 2.

Referring now to FIG. 2, a flowchart illustrating the steps in a method of evaluating a security of a company of interest in an embodiment of the present invention is shown generally as 100. In this embodiment, the steps may be performed by a processing engine (e.g. processing engine 40 of FIG. 1) of a security evaluation system (e.g. security evaluation system 10 of FIG. 1).

In this embodiment, the security evaluation system computes values for a set of first assessment measures that include pre-defined measures reflecting the quality of a company, and for a set of second assessment measures that include pre-defined measures reflecting the value of a company. Fundamental composite measures associated with a company are also computed. These include quality composite measures and value composite measures, reflecting the quality and value of the company respectively. However, in variant embodiments of the invention, different types of assessment measures and composite measures that reflect other aspects of companies, other than their quality and value, may be used.

At step 110, data retrieved from external data providers or data sources (e.g. from publicly available financial statements) is preprocessed before being used to populate a system database (e.g. system database 20 of FIG. 1). The security evaluation system is fed by numerous data feeds from which data is obtained on companies that are to be potential candidates for evaluations that are to be performed by the system. Typically, the longer a company has been in business, the better that company will be as a candidate for evaluation. It is also preferable that a company practices similar accounting practices as its peers in a group of interest. Analyses can be performed to reduce the universe of potential candidates for the evaluation process to only those which meet these and other criteria as may be specified by the user or implementer of the present invention. A list of companies and a list of securities issued by those companies can then be generated. The following are examples of some of the sets of companies and securities that may be built:

(i) CS_UNIVERSE_COMPANY: main set of companies

(ii) CS_UNIVERSE_COMPANY_CI: main set of securities

(iii) CS_INDEXES: main set of indices (e.g. S&P 500)

(iv) CS_BANKS: main set of banks

(banks have been considered separately as they have slightly different models from other companies due to different accounting standards).

The processing engine may be programmed to execute various extract routines on the different data sources used to populate the system. The data can be exported from the original source into a data file and possibly manipulated, for uploading into the system database.

Once the potential sets of companies are built, a set of simplified data items is generated by the processing engine, and stored in the system database. The processing engine renders thousands of data items to a significantly smaller number (e.g. in the order of one hundred in the Q.V. System) of modeling blocks for each company that may be evaluated by the system. These simplified data items are values that result from the application of algorithms that model characteristics (i.e. financial concepts) of a company, index, or industry. The primary purpose of generating simplified data items is to speed up the computation of other financial concepts that are dependent upon them, and to build a history of these items. Some examples of these simplified data items used in one example implementation of the present invention include:

(i) EST12M_I: 12 month forward forecast of earnings

(ii) SPI_{—}12: special accounting items that a company reported over the past 12 months

(iii) CFLX12_I: trailing 12 month cash flow amount

(iv) CFLINT_I: a score that records the level of a company's cash flow change over the past 12 months (example range=−133.33 to 133.33)

(v) INIDUS_I: a score that records a company's combined changes to earnings per share, sales, and cash flow over the trailing 12 months (example range=−400 to 400)

(vi) ROEAVG: a company's 8 year average return to shareholders equity

(vii) GBU9AVG: GBU9 is a percentage that reflects a company's ability to cover its own capital spending and financing activities. GBU9AVG is the 8 year average of this number.

(viii) PETAVG: average price/earnings ratio using trailing earnings

(ix) PAENTVAL: a price/enterprise value ratio

(x) GBU1SC_I: a company's market relative profitability using annual or calendar year end information. This is a score calculated from information on a company's income statement. Selected ratios such as return on equity, return on assets, reinvestment rates, etc. are compared to similar market ratios. The results may then be weighted and combined into a score that, for example, ranges from −400 to 400. In this example, generally, a company that scores 200 on this scale represents a company that is approximately twice as profitable as the market in general.

(xi) GBU2SC_I: a company's market relative financial strength using annual or calendar year end information. This is a score calculated from information on a company's balance sheet. Selected ratios such as interest rate coverage, equity to debt, etc. are compared to similar market ratios. The results may then be weighted and combined into a score that, for example, ranges fro −400 to 400. In this example, generally, a company that scores 200 on this scale represents a company that has approximately twice the balance sheet strength as the market in general.

(xii) GBU4SC_I: a trailing 12 month version of GBU1SC_I

(xiii) GBU5SC_I: a trailing 12 month version of GBU2SC_I

The simplified data items described above are provided by way of example only, and are not intended to limit the scope of the present invention.

Accordingly, the system database is comprised of pre-calculated and model-specific information. The following tasks are performed in a typical process of building simplified data items:

(i) cleaning, adjusting for outliers, and normalizing the data (e.g. overriding any outlier data with maximum values, or using a company's industry average where data does not exist);

(ii) building an information hierarchy in which similar items are weighted by importance, where the most heavily weighted item would typically be selected for use in an evaluation; for example, with respect to earnings numbers, an information hierarchy might comprise the following items: 12 month forecasted earnings, normalized earnings, 12 month trailing earnings, and last quarter earnings; the application of the information hierarchy increases the likelihood that a null value will not be obtained when an evaluation based on any particular item is performed; and

(iii) managing data from multiple data sources.

There are several advantages to populating the system database with simplified data items. For example, this permits the standardization of information, the reduction of potentially thousands of data items associated with a company to be reduced to a more manageable number to provide for greater processing efficiency, an increase in processing speed (e.g. historic data points can be pre-calculated for each company on a very specific set of historical data which can be made readily available for further analysis—for example, a 12 month trailing price-earnings value does not have to be calculated each time it is used by rather a stored value representing the most recent 12 month trailing price-earnings value can be retrieved as needed), and an increase in the accuracy in the evaluation process (e.g. as the use of information hierarchies increases the likelihood that any given evaluation may be performed rather than a null value be returned that could spoil a modeling procedure).

The security evaluation system may optionally be designed to allow a user to define various parameters or preferences. If so, these preferences may be entered through a user interface (e.g. user interface 30 of FIG. 1) at step 120. At step 120, for example, the user may select or define a specific peer group in which the company of interest belongs. A custom group of interest or portfolio of companies of interest may be defined by the user. For example, groups of interest may be derived from GICS sectoring. At this step, the user may also define or select different assessment measures that are to be calculated by the security evaluation system, or define or select different weights that are to be applied to specific assessment measures or relative scores used in the calculation of fundamental composite measures, for example. This can permit a user (e.g. an investment analyst) to influence how securities are to be evaluated with their own investment biases.

At step 130, values are calculated for a set of first assessment measures, which in this embodiment of the invention, are measures that reflect of the quality of a company. Accordingly, in this embodiment, these first assessment measures may also be referred to as quality assessment measures or Quality fundamentals.

Quality Fundamentals

The quality of a company is determined on a peer relative basis. Quality fundamentals used by a security evaluation system may be calculated on a daily basis with the most recently available information from external databases, if desired. For example, Quality fundamentals may include the assessment measures described below.

Profitability

This quality assessment measure reflects a company's market-relative profitability. The value of this quality assessment measure for a company is calculated from commonly used profit measures that may be typically retrieved from the company's income statement. A selection of ratios such as return on equity (ROE), return on assets (ROA), and reinvestment rates, for example, are compared to similar market ratios. Under the methodology used to calculate this quality assessment measure in an example implementation of the invention, and as described in further detail below, valuations of these ratios are weighted and combined into a profitability score that ranges from −400 to 400. This profitability score is the value of this quality assessment measure that is associated with a company, determined on a market-relative basis. As indicated earlier, generally, a company with a profitability score of 200 may be considered to be approximately twice as profitable as the market in general.

A profitability score can be calculated for each company in a specific peer group using the following ratios or simplified data items, for example:

(i) 5-year average return on equity (ROE Avg);

(ii) current return on assets (ROA);

(iii) current gross return on assets (RGRA);

(iv) current reinvestment rate (REINVT);

(v) free cash flow as a % of working assets (Freecash %); and

(vi) 5-year projected growth rate (5 yr growth).

These ratios are calculated for each company in the “universe” of companies for which data is stored in the system database.

To arrive at a profitability score for a company, we divide each of the ratios for each of the companies in an applicable peer group by a market benchmark ratio, and multiply the result by 100. This results in a market relative multiple for each ratio. A weighted average of the multiples produces a company's profitability score, which is bounded (capped) between −400 and +400. Therefore, a profitability score of 100 calculated in accordance with this methodology would indicate that the company has a profitability ranking equal to the market benchmark. The following table illustrates an example of the calculation of a profitability score for an example company X:

| | | Market | Market |
|---|---|---|---|
| Ratios | Company X | Benchmark | Relative Multiple |
| ROE Avg | 15 | 20 | 75 (e.g. 15/20*100) |
| ROA | 12 | 14 | 86 |
| RGRA | 13 | 15 | 87 |
| REINVT | 10 | 12 | 83 |
| Freecash % | 7 | 6 | 117 |
| 5 yr growth | 25 | 15 | 167 |

| | |
|---|---|
| Overall Profitability Score | 103 |

Financial Strength

This quality assessment measure reflects a company's market-relative financial strength. The value of this quality assessment measure for a company is calculated from commonly used balance sheet measures typically retrieved from the company's balance sheet. A selection of ratios such as interest coverage and equity to debt, for example, are compared to similar market ratios. Under the methodology used to calculate this quality assessment measure in an example implementation of the invention, and as described in further detail below, valuations of these ratios are weighted and combined into a financial strength score that ranges from −400 to 400. This financial strength score is the value of this quality assessment measure that is associated with a company, determined on a market-relative basis. Generally, a company with a financial strength score of 200 may be considered to have approximately twice the balance sheet strength as the market in general.

For example, a financial strength score, a simplified data item, can be calculated for each company in a specific peer group using the following ratios:

(i) Interest coverage (Int cover);

(ii) Debt repayment capability (debt repay);

(iii) Debt to Equity (debt/equity); and

(iv) 5-year average self finance capability (5 yr self fin).

These ratios are calculated for each company in each peer group and also for a market benchmark, such as the S&P 500.

To arrive at a financial strength score for a company, we divide each of the ratios for each of the companies in an applicable peer group by the market benchmark ratio, and multiply the result by 100. This results in a market relative multiple for each ratio. A weighted average of the multiples produces a company's financial strength score, which is bounded (capped) between −400 and +400. Therefore, a financial strength score of 100 calculated in accordance with this methodology would indicate that the company has a financial strength ranking equal to the market benchmark. The following table illustrates an example of the calculation of a financial strength score for an example company X:

| | | Market | Market |
|---|---|---|---|
| Ratios | Company X | Benchmark | Relative Multiple |
| Int cover | 1.5 | 2.0 | 75 (e.g. 1.5/2.0*100) |
| Debt repay | 2.5 yrs | 3.0 yrs | 120 |
| Debt/Equity | 1.3 | 1.0 | 77 |
| 5 yr self fin | 25% | 85% | 29 |

| | |
|---|---|
| Overall Financial Strength Score | 75 |

It will be understood by persons skilled in the art that different ratios might be used to compute financial strength depending on the type of company being evaluated. For example, a class of companies such as banks may require different calculations. Typically, a bank's financial strength is predicated on a selection of loan book ratios such as non-performing assets and T-1 cap ratios and reserves. These characteristics can be taken into account in computing an appropriate financial strength score to be associated with companies of this class.

Interim Indicator

This quality assessment measure reflects a company's year-to-year results in sales, cash flow, and earnings. A score can be computed that reflect a company's progress on a market-relative basis is computed that ranges from −400 to 400. Generally, companies generating the strongest interim results will be assigned a high positive score, while companies with decreases in interim results will show negative scores.

Estimate Momentum

Estimate momentum is measured as a percentage change in the estimates of future earnings over time. More recent changes have higher weight in the methodology used in this embodiment of the invention. Estimate momentum is weighted in two ways. One weight reflects the age of the percentage change in the actual estimate. The second weight reflects the fiscal year end of the company being measured.

To calculate this assessment measure, first, changes in analysts' estimates are measured over 3 months. The most recent monthly change receives the highest weight. An equation for this time series weighting used in one example implementation is:

Time weighted change=0.6×EST(0)/EST(−1)+0.3×EST(−1)/EST(−2)+0.1×EST(−2)/EST(−3)

where EST(x) is the estimate of future earnings at time t=x.

The equation above is applied to each company in each peer group for expectations for the current fiscal year (FY1) and the next fiscal year (FY2). This results in two respective time weighted change values: WCHFY1 and WCHFY2.

The next operation combines the weighted change values according to a given company's fiscal year in conjunction with the current calendar month. More specifically, for each company, this number is calculated by examining the calendar month of the fiscal year for that particular company. For example, a company with a December year-end would receive a 0.25 score (called PECW6T in this example) to reflect that there is 25% left in the company's current fiscal period. The following equation is used to combine the two fiscal years of information:

ESTMOM=PECW6T×WCHFY1+(1−PECW6T)×WCHFY2

This equation combines the two estimated momentum results from fiscal year 1 and 2.

Other Quality Assessment Measures

Other quality assessment measures may also be computed to be used in subsequent calculations by the security evaluation system, including, for example:

(i) a measure of a company's estimated long-term growth, which may be a composite of the company's normal and expected future growth for example;

(ii) a measure of estimate dispersion;

(iii) a measure of a company's specific risk, which may be a function of company size, historic EBITDA variability, economic sensitivity and the company's absolute investment value as measured by a price multiple composite for example; and

(iv) any other measure that may be user-defined or known in the art.

At step 130, values are also calculated for a set of second assessment measures, which in preferred embodiments of the invention, are measures that reflect of the value of a company; accordingly, in this embodiment, these first assessment measures may also be referred to as value assessment measures or Value fundamentals.

Value Fundamentals

The value of a company is determined on a peer relative basis. Value fundamentals used by a security evaluation system may be calculated on a daily basis with the most recently available information from external databases, if desired. For example, prices of a security (“Price”) used in calculations may reflect the price at the prior day's close; earning estimates and media reported results updated on a daily basis might also be used. For example, Value fundamentals may include the assessment measures described below.

P/E Trailing Earnings (P/E_{Trail})

The value of this value assessment measure is determined by: Price divided by trailing 12 month earnings per share (EPS). If the trailing 12 month earnings are not available, the last annual earnings are used. Values of this assessment measure for companies having negative earnings or P/E_{Trail}s above 50 are capped at 50 (example range: 0 to 50)

P/E Forecasted 12 Month Earnings (PIE_{fcst})

The value of this value assessment measure is determined by: Price divided by forecasted 12 month earnings per share. Forecasted earnings for FY1 and FY2 are combined based on the company's calendar year end, to provide a moving 12 month forecast of earnings. Companies with negative forecasted earnings or P/E_{fct}s above 50 are capped at 50 (example range: 0 to 50)

P/E Normal Earnings (P/E_{normalized} or P/Eₙₒᵣₘₐₗ)

The value of this value assessment measure is determined by: Price divided by normalized earnings per share. Normal earnings are based on trend estimates of earnings and earnings potentials for each company. Normal earnings represent the midpoints of each company's earnings cycle. Companies with negative normal earnings or P/E_{normalized}s above 50 are capped at 50 (example range: 0 to 50).

More specifically, normalized or potential earnings for a company may be calculated by combining a selection of commonly used earnings estimation techniques. For example, normalized earnings may be calculated by combining weighted averages of the following items:

(i) Forecast trend earnings—calculate forecast trend earnings by using an ordinary least squares calculation on quarterly reports of 12 month trailing earnings;

(ii) Book potential earnings—calculate book potential earnings by multiplying 5 yr average ROE by current book value to estimate earnings;

(iii) Peak earnings potential—calculate difference from past peak earnings cycle plus 20%; and

(iv) 12 month out forecast earnings—Fiscal year adjusted 12 month out earnings estimates.

The weighted average of the earnings models above tend to smooth out cyclical earnings, due to a reducing effect on extraordinary events. The estimate is particularly valuable in identifying peaks and troughs of market earnings cycles. This normal earnings figure may be used not only to calculate price to normal earnings (P/E_{normalized}), but also to calculate P/E_{normalized} to 5 yr expected growth.

Price to (Forecast or Trailing) Cash flow (P/CFL)

The value of this value assessment measure is determined by: Price divided by forecasted cash flow or 12 month trailing cash flow per share (depending on availability). 12 month cash flow equals earnings less special items plus depreciation plus amortization plus deferred taxes. Companies with negative cash flow or P/CFLs above 30 are capped at 30 (example range: 0 to 30).

Price to Book value (P/BK)

The value of this value assessment measure is determined by: Price divided by reported book value (common equity divided by shares outstanding). Companies with negative book or P/BKs above 20 are capped at 20 (example range: 0 to 20).

Price to 12 Month Trailing Sales (P/Sales)

The value of this value assessment measure is determined by: Price divided by 12 month trailing sales or last annual sales. Companies with P/Sales above 10 are capped at 10 (example range: 0 to 10).

Enterprise Value to EBITDA (ENTVAL/EBITDA)

Enterprise value is calculated by adding up the company's stock market value and all debt. EBITDA is operating earnings before interest and depreciation and taxes. Companies with negative EBITDA or ENTVAL/EBITDA over 50 are capped at 50 (example range: 0 to 50).

P/E to Estimated Growth (P/E_{Growth})

The value of this value assessment measure is determined by: P/E based on normal earnings (i.e. P/E_{normalized}) divided by estimated 5 year growth or past average ROE. Companies with negative growth or P/E_{Growth} above 5 are capped at 5 (example range: 0 to 5).

Other Value Assessment Measures

Other value assessment measures may also be computed, for use in subsequent calculations by the security evaluation system, as defined by a user or known in the art. In variant embodiments of the invention, additional assessment measures and/or different assessment measures may be calculated at step 130.

Steps 140 through 170 are performed by the security evaluation system to obtain a quality composite measure for the company of interest. The security evaluation system utilizes benchmarking to determine a set of relative first scores, where each of these relative first scores is associated with a specific quality assessment measure in the calculation of the company's quality composite measure in an embodiment of the present invention.

At step 140, the mean and standard deviation of the values of a specific quality assessment measure for all companies in the group of interest (e.g. an industry sector) is calculated. This calculation can be performed for each of any number of peer groups (e.g. industry groups) of interest nightly, if desired.

At step 150, the value of the quality assessment measure considered at step 140 for the company of interest is identified (“raw value”).

At step 160, once the benchmark for each peer group is known, the value of the quality assessment measure for the company of interest can be compared to the industry sector mean. A relative quality score associated with the specific quality assessment measure considered at step 140 can be obtained by comparing the value of the quality assessment measure for the company of interest obtained at step 150 to the mean calculated at step 140. The relative quality score can be calculated as a standardized score based on the standard deviation calculated at step 140, such that the relative quality score reflects the quality of the company of interest under the specific quality assessment measure being considered, as a number of standard deviations above or below the mean. The following equation may be used to obtain the relative quality score associated with the specific quality assessment measure being considered:

Relative quality score=(value of quality assessment measure for company of interest−mean)/standard deviation

Steps 140 through 160 are repeated for each quality assessment measure that is to be used in the evaluation of the security of the company of interest. The quality assessment measures to be used in the evaluation may be pre-determined by an implementer of the present invention, or may be defined by a user, as at step 120.

At step 170, the quality composite measure is calculated by summing the relative quality scores associated with the company of interest for all the quality assessment measures being used in the evaluation. Optionally, in calculating the quality composite measure, weights may be assigned to different relative quality scores and applied in calculating the quality composite measure.

The quality composite measure is created based on the relative difference in fundamental quality values. Companies with higher quality than the industry sector average based on the Quality fundamentals will have a quality composite measure above zero. Companies with quality composite measures below zero have lower fundamental quality than the industry sector average.

Ranges for quality composite measures are dependent on the standard deviations of quality assessment measures for companies within the industry sector, but are capped at 2 standard deviations above and below the average. For example, a company with a quality composite measure value of 1 as calculated by the security evaluation system displays higher quality than 66% of the other companies in the industry sector.

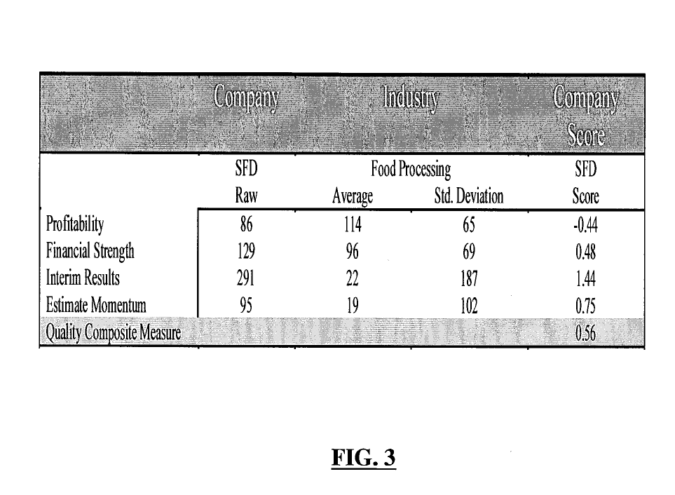

A sample table illustrating the values obtained in calculating a quality composite measure for an example company, Smithfield Foods (SFD) is provided in FIG. 3. The quality composite measure calculated for SFD suggests that SFD is about 0.56 standard deviations higher quality than the average food processing company.

Referring back to FIG. 2, steps 180 through 210 are performed by the security evaluation system to obtain a value composite measure for the company of interest. The security evaluation system utilizes benchmarking to determine a set of relative second scores, where each of these relative second scores is associated with a specific value assessment measure in the calculation of the company's value composite measure in this embodiment of the present invention.

At step 180, the mean and standard deviation of the values of a specific value assessment measure for all companies in the user-defined group (e.g. an industry sector) is calculated. This calculation can be performed for each of any number of industry groups of interest nightly, if desired.

At step 190, the value of the value assessment measure considered at step 180 for the company of interest is identified (“raw value”).

At step 200, the value of the value assessment measure for the company of interest can be compared to the industry sector mean. A relative value score associated with the specific value assessment measure considered at step 180 can be obtained by comparing the value of the value assessment measure for the company of interest obtained at step 190 to the mean calculated at step 180. The relative value score can be calculated as a standardized score based on the standard deviation calculated at step 180, such that the relative value score reflects the value of the company of interest under the specific value assessment measure being considered, as a number of standard deviations above or below the mean. The following equation may be used to obtain the relative value score associated with the specific value assessment measure being considered:

Relative value score=(value of value assessment measure for company of interest−mean)/standard deviation

Steps 180 through 200 are repeated for each value assessment measure that is to be used in the evaluation of the security of the company of interest. The value assessment measures to be used in the evaluation may be pre-determined by an implementer of the present invention, or may be defined by a user, as at step 120.

At step 210, the value composite measure is calculated by summing the relative value scores associated with the company of interest for all the value assessment measures being used in the evaluation.

Optionally, in calculating the value composite measure, weights may be assigned to different relative value scores, and applied in calculating the value composite measure. It may be appropriate to use different weights and/or different value assessment measures or price multiples depending on the industry sector in which the company of interest is being evaluation. For example, the value of P/E to estimated growth might be more important for a company in the technology industry than it would be for one in the oil and gas industry. Accordingly, a number of different weighting schemes may be used by the security evaluation system to determine a company's value composite measures for different industries and industry sectors of interest.

As illustrated above, a value composite measure is created based on the relative difference in value assessment measure (e.g. price multiple) values. Companies with a higher value (i.e. cheaper) compared to the industry sector average based on the value assessment measures (e.g. price multiples) will have a value composite measure above zero. Companies with value composite measures below zero are more expensive than the industry sector average.

Ranges for value composite measure are dependent on the standard deviations of the value assessment measures for companies within the industry sector, but is capped at 2 standard deviations above and below the average. For example, a company with a value composite measure value of 1 as calculated by the security evaluation system displays higher value than 66% of the other companies in the industry sector.

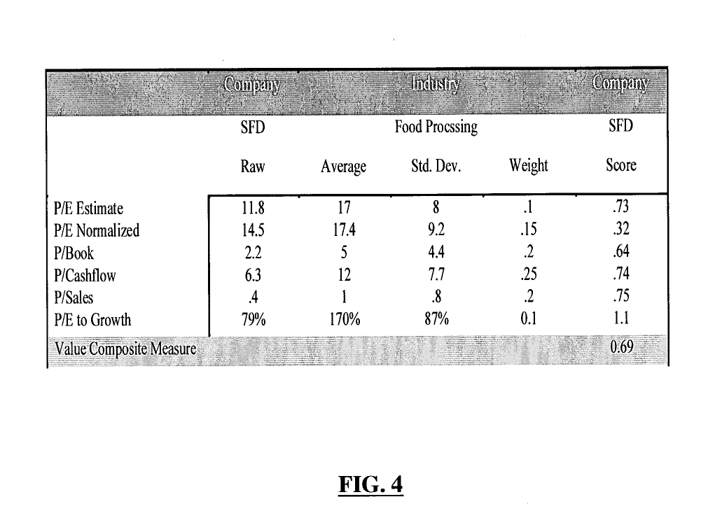

A sample table illustrating the values obtained in calculating a value composite measure for the example company, Smithfield Foods (SFD) is provided in FIG. 4. SFD's value composite measure of 0.69 standard deviations above the mean suggests that the company has a higher value than its peers. A user may consider this investment candidate in the food industry as favourable, since its quality and value composite measures are both above average relative to others in the industry sector under consideration.

Referring back to FIG. 2, at step 220, other assessment measures or composite measures for the company of interest may be calculated by the security evaluation system. This may include, for example, a market capitalization measure, a risk composite measure, and/or other measures defined by a user or known in the art.

Risk Composite Measure

The security evaluation system may be adapted to generate a composite measure that reflect a company's overall risk with respect to economic sensitivities and its current earnings cycle. For example, a risk model may be used that compares a company's values for a number of variables to market values, to measure expected price variability. The variables that may be combined and weighted to create a risk profile could include, for example:

(i) Market capitalization;

(ii) Current earnings versus normal earnings;

(iii) Historic EBITDA variability;

(iv) Current earnings versus peak earnings; and

(v) Arbitrage Pricing Theory (APT) risk factor score.

Application of this risk model results in the calculation of a risk estimate that is relative to the market. The risk is reported in percentages, where a company that has a risk percentage of 20% would be viewed as having 20% more risk than the market in general.

At step 140, output based on the assessment measures and composite measures calculated by the security evaluation system may be provided to a user. Output that a user may desire and which the security evaluation system may be adapted to generate can be in a variety of forms, and the following outputs and output formats are provided by way of example only.

Charts or Symbolgrams™

A chart or graph can be generated by the security evaluation system from the fundamental composite measures calculated for each company in a group (e.g. industry sector) of interest. The chart serves as a visual representation of how companies in the group compare to one another on the basis of the assessment measures from which the fundamental composite measures are calculated.

In one embodiment of the invention, the chart is represented by a graph based on an X-Y coordinate system. Although the chart appears two-dimensional and is based on a Cartesian coordinate system in this embodiment, charts of higher dimensions and/or based on different coordinate systems may be used in variant embodiments of the invention.

In generating this chart as output in this embodiment of the invention (also referred to as a Symbolgram™ in an implementation of this embodiment developed by the assignee of the present invention), a position on the coordinate system is derived for a company from its quality and value composite measures. An identifier is placed on the chart (e.g. the ticker symbol under which securities of the company trades) at the derived position.

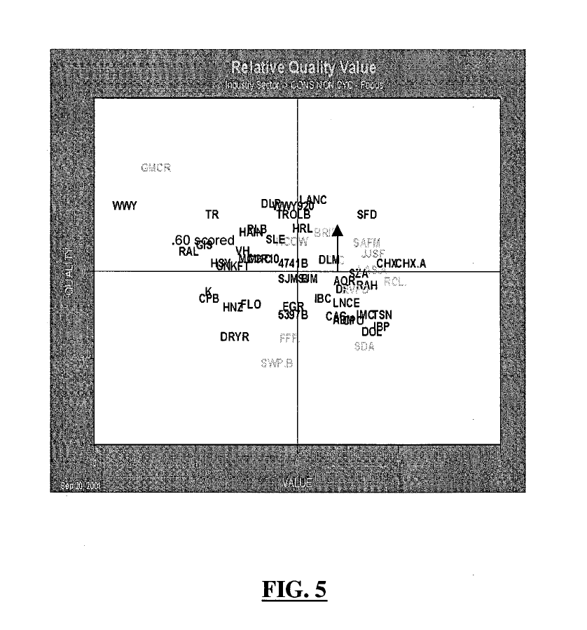

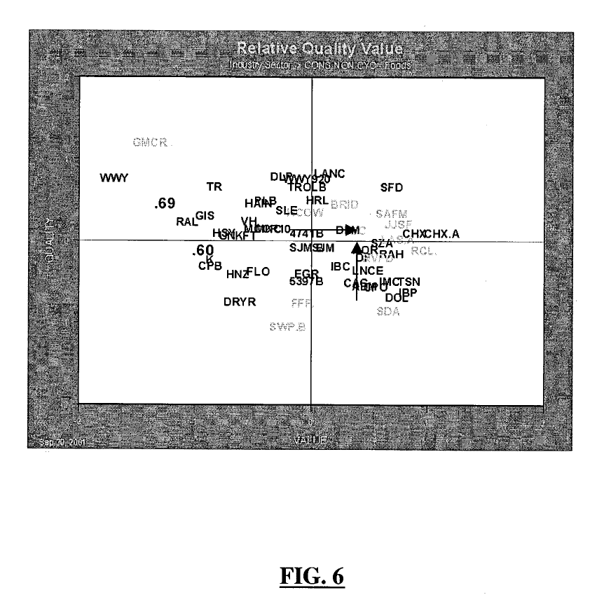

Referring to FIGS. 5 and 6, sample charts are shown illustrating how an identifier for the example company SFD is placed on a Quality-Value chart (“Q.V. Chart”). The Q.V. Chart is calibrated according to standard deviation units on both the horizontal and vertical axes, where zero is at the origin and each axis extends from −2 to +2 standard deviations (although other ranges may be displayed). The vertical position of the identifier “SFD”, as shown in FIG. 5, is at 0.60 (standard deviation) units on the vertical quality axis, derived from SFD's quality composite measure. The horizontal position of the identifier “SFD”, as shown in FIG. 6, is at 0.69 (standard deviation) units on the horizontal value axis, derived from SFD's value composite measure. Identifiers for all other companies in the industry sector of interest are similarly plotted on the chart. The position of identifiers on the graph indicates the relative quality and value of companies relative to others, as determined by the security evaluation system.

Similarly, a chart may be generated to display identifiers for all companies in a specific portfolio of interest, by plotting an identifier for each company in the portfolio at a position derived from the company's quality and value composite measures. Each company will typically be presented in the same location (assuming identical scales) as it would have been in a chart providing an industry sector view. The chart can provide a quick forward-looking view on the investment style underlying a specific portfolio. Weighted portfolio composite measures that are a function of the quality and value composite measures for the companies in the group and which reflect the weights of the securities in the portfolio can be computed, and these may be used in generating the chart or other output to the user.

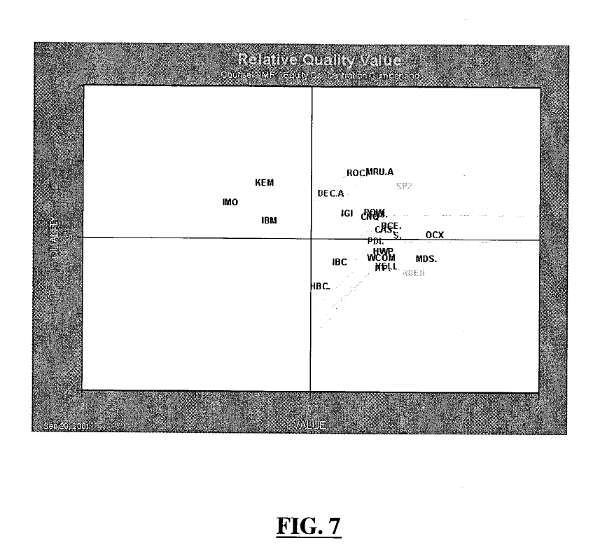

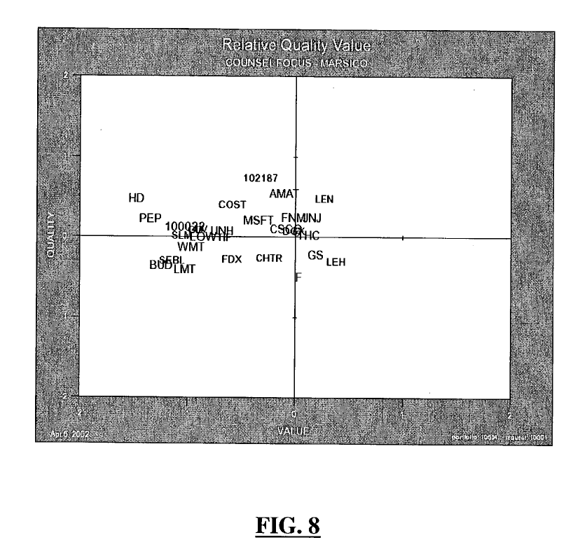

For example, one can determine if the manager of a particular portfolio gravitates to higher quality or inexpensive companies for the industries invested in, at a glance. A Q.V. Chart makes it relatively easy to distinguish a value manager from a turn-around specialist or growth manager, and can be used to compare different portfolios. For example, FIG. 7 illustrates a sample chart associated with a first example portfolio, which appears to suggest an underlying value investment strategy since the companies are concentrated in the right half of the chart, whereas FIG. 8, which illustrates a sample chart associated with a second example portfolio, appears to suggest an underlying growth investment strategy since the companies are concentrated in the left half of the chart.

In general, identifiers located in the upper left quadrant of the chart represent relatively high quality and expensive companies, whereas identifiers located in the upper right quadrant represent relatively high quality and inexpensive companies. Conversely, identifiers located in the lower left quadrant represent relatively low quality and expensive companies, whereas identifiers located in the lower right quadrant represent relatively low quality and inexpensive companies.

There are numerous ways of representing additional information associated with companies depicted in the chart. For example, the chart could be depicted as a three (or higher) dimensional object, where the position of an identifier relative to a third (or other) axis provides additional information on the underlying company.

As a further example, identifiers can also be colour-coded. Varying shades of colour can be used to categorize companies in a manner as desired by a user, or by an implementer of the present invention. Similarly, identifiers can be represented in different font styles and/or font sizes.

For example, a chart may be constructed where quality is depicted on the vertical axis, value is depicted on the horizontal axis, the font size represents market capitalization of a company (e.g. the larger the font size, the larger the market capitalization), and where the colour of the identifier reflects the risk of the company (e.g. the more blue, the less the risk, the more red, the greater the risk).

It will be obvious to those skilled in the art that the appearance of a chart or graph may differ in variant implementations of the present invention. For example, the axes may represent different assessment measures other than quality and value, if different assessment measures were calculated by the security evaluation system.

Target Prices

Once the quality and value composite measures are calculated, the security evaluation system may produce a target price for the company of interest. The logic behind the calculation of a target price is based on the belief that markets or industries are somewhat efficient over the longer term. Thus companies with higher quality should be valued differently from companies with lower quality. This quality differential should be reflected in a company's price multiples. Companies that are clearly of higher quality should trade at higher multiples, and in an efficient world, they would be found in the upper left quadrant of a Q.V. Chart. Companies of lower quality should be found in the lower right quadrant of a Q.V. Chart. A company of demonstrated higher quality should trade at premium multiples commensurate with the standard deviation in higher quality. Since the average and spread in multiples for each industry is known, it is possible to calculate a target price that a company's security should trade at. For example, a company having good quality relative to its peers should be more expensive than its peers. Ultimately, the target prices that would reflect this disparity can be calculated.

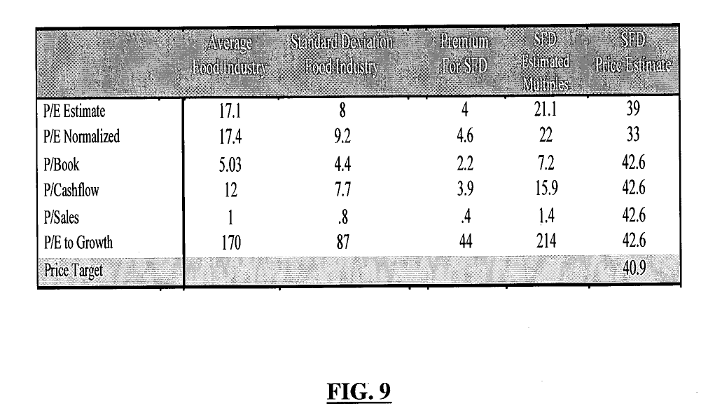

For example, with respect to the example company SFD for which quality and value composite measures were calculated and provided in FIGS. 3 and 4, it can be estimated that SFD, of 0.6 standard deviations higher quality than the mean, would trade, in an efficient market, with multiples one-half of the standard deviation for the specific price multiple greater than the average of the respective price multiple for the Food Processing sector. In this example implementation of the invention, when calculating peer relative value, a one-to-one relationship between the value and quality scores is not used to calculate price multiples. Instead, the potential price multiples reflect approximately 0.75 times the quality composite measure. Although this adjustment factor was determined as being suitable by an implementer of an embodiment of the present invention in this example, other adjustment factors may be used in variant embodiments of the invention. The price multiples and resulting prices for this example are shown in FIG. 9, in which a table illustrating how a target price is calculated for the example company SFD is provided.

Referring to FIG. 9, the target price for SFD indicates the company should trade at twice its current price based on its relative quality and price multiples that reflect its higher quality. The calculation of the target price relies on the same weights that are used in the calculation of the value composite measure. Target price estimates are capped at a ceiling of 2 times the current price.

Using the target price as a basis for a buy or sell recommendation typically also requires a view or an opinion on the relevant industry sector. An industry with companies trading at extremely high multiples may, as a group, be at risk. Companies having higher value relative to their peers, that are in a peer group that is expensive relative to the other peer groups or the market will generally have less overall industry or peer group related risk.

Reports

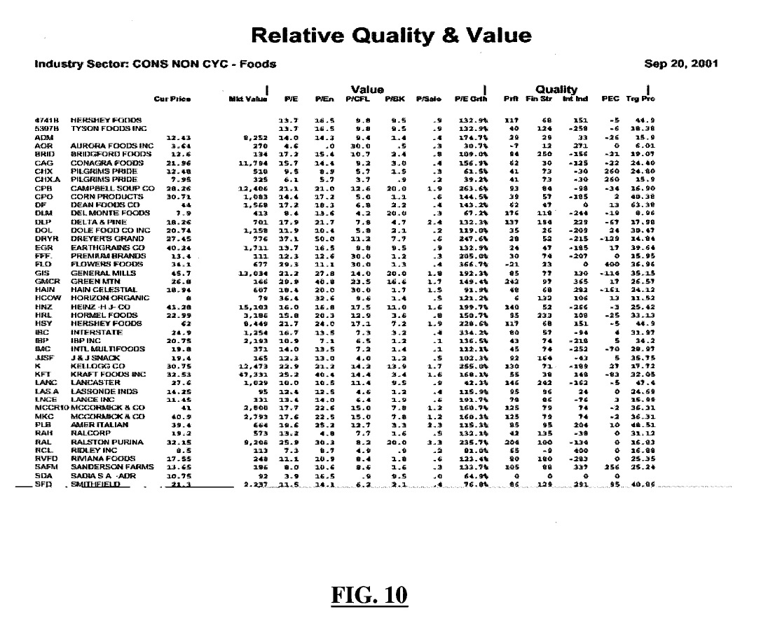

Various types of reports may be generated by the security evaluation system. For example, FIG. 10 is a sample report that summarizes the values of a variety of quality assessment measures, value assessment measures, and target prices for numerous companies in an industry sector of interest. Such reports may be used by users of the security evaluation system, in conjunction with other outputs, to further evaluate a company of interest.

It will be obvious to those skilled in the art that there are numerous possible configurations of the components of the security evaluation system (e.g. security evaluation system 10 of FIG. 1) described herein that may exist in variant embodiments of the present invention. For example, the components of the security evaluation system may be distributed across a plurality of computing servers or systems, including web-based servers or system for example, as chosen by an implementer of the present invention for performance, security, robustness, or other reasons. Alternatively, the components of the security evaluation system may exist on a single computing device. Firewalls may be implemented in the security evaluation system to prevent unauthorized access to private information.

The components of the security evaluation system may also be coupled through one or more network connections, which may include an Internet and/or Intranet connection, for example. Similarly, the security evaluation system may be coupled to external systems or data sources (e.g. financial databases) through one or more such network connections.

Furthermore, with respect to components of the security evaluation system as described in this specification, it will be understood by persons skilled in the art that the execution of various tasks associated with the methods of the present invention need not be performed by the particular component specified in the description of embodiments of the invention, and that many configurations of the security evaluation system are possible without departing from the scope of the present invention. For example, it will be obvious to those skilled in the art that the performance of tasks by a processing engine (e.g. processing engine 40 of FIG. 1) may be performed by a different engine, and through the use of one or multiple processing modules. The instructions performed by these processing modules may also be wholly or partially stored on a computer-readable medium.

It will also be obvious to those skilled in the art that the data stored in the system database referred to herein (e.g. system database 20 of FIG. 1) may be distributed across multiple logical and physical storage devices, including memories, databases, and/or other storage media for example.

The present invention has been described with regard to preferred embodiments. However, it will be understood by persons skilled in the art that a number of other variants and modifications can be made without departing from the scope of the invention as defined in the appended claims.

1. A method of evaluating a security issued by a company of interest, the method to be performed by a computer, wherein the method comprises the following steps:
a) computing a value for one or more quality assessment measures for each company of a group of companies;
b) computing a value for one or more value assessment measures for each company of the group;
c) for each quality assessment measure, computing a first mean and a first standard deviation of the values therefor across all companies in the group and computing a relative quality score associated therewith for the company of interest, the relative quality score being a function of the first mean and the first standard deviation;
d) for each value assessment measure, computing a second mean and a second standard deviation of the values therefor across all companies in the group and computing a relative value score associated therewith for the company of interest, the relative value score being a function of the second mean and the second standard deviation;
e) computing a quality composite measure for the company of interest, wherein the quality composite measure is a function of the relative quality scores associated with at least one quality assessment measure;
f) computing a value composite measure for the company of interest, wherein the value composite measure is a function of the relative value scores associated with at least one value assessment measure; and
g) generating output to the user based on the quality and value composite measures for the company of interest, whereby the output reflects a valuation of the company of interest relative to other companies in the group.

2. The method as claimed in claim 1, wherein the relative quality score associated with each quality assessment measure is computed by dividing the difference between the first mean and the value of the respective quality assessment measure for the company of interest by the first standard deviation.

3. The method as claimed in claim 2, wherein the quality composite measure is computed as a weighted sum of the relative quality scores associated with at least one quality assessment measure.

4. The method as claimed in claim 3, wherein a plurality of user-defined weights are used to compute the weighted sum of the relative quality scores associated with at least one quality assessment measure.

5. The method as claimed in claim 1, wherein the relative value score associated with each value assessment measure is computed by dividing the difference between the second mean and the value of the respective value assessment measure by the second standard deviation.

6. The method as claimed in claim 5, wherein the value composite measure is computed as a weighted sum of the relative value scores associated with at least one value assessment measure.

7. The method as claimed in claim 6, wherein a plurality of user-defined weights are used to compute the weighted sum of the relative value scores associated with at least one quality assessment measure.

8. The method as claimed in claim 1, wherein steps (a) through (g) are repeated for each company in the group.

9. The method as claimed in claim 8, further comprising the steps of deriving a position on a chart for each company in the group from the quality composite measure and the value composite measure therefor, and generating a chart in which an identifier associated with each company in the group is displayed on the chart at the position derived therefor, wherein the chart is output to a user at step (g), and whereby the position of the identifiers in the graph illustrates the relative values of the quality and value composite measures of the companies in the group.

10. The method as claimed in claim 9, further comprising the step of computing a risk composite measure for each company in the group, wherein the identifier associated with each company as displayed in the chart reflects the value of the risk composite measure computed therefor.

11. The method as claimed in claim 10, wherein the color of the identifier associated with each respective company in the chart reflects the value of the risk composite measure computed therefor.

12. The method as claimed in claim 9, further comprising the step of computing a market capitalization measure for each company in the group, wherein the identifier associated with each company as displayed in the chart reflects the value of the market capitalization measure computed therefor.

13. The method as claimed in claim 10, wherein the font size of the identifier associated with each respective company in the chart reflects the value of the market capitalization measure computed therefor.

14. The method as claimed in claim 1, wherein the companies in the group belong to the same industry sector.

15. The method as claimed in claim 1, wherein the companies in the group are associated with a plurality of securities held in a user-defined portfolio.

16. The method as claimed in claim 15, further comprising the steps of computing and outputting a weighted portfolio composite measure, wherein the weighted portfolio composite measure is a function of the quality and value composite measures for the companies in the group, and wherein the weighted portfolio composite measure reflects the weights of the securities in the portfolio.

17. The method as claimed in claim 1, wherein the output includes a target price for the security issued by the company of interest.

18. The method as claimed in claim 17, wherein the output further includes a report containing target prices for each company in the group.

19. The method as claimed in claim 17, wherein said output further includes a buy or sell recommendation based on said target price.

20. The method as claimed in claim 1, wherein the method further comprises the step of computing a plurality of simplified data items from data in one or more financial databases, for use in subsequent computations of quality and value assessment measure values for companies in the group.

21. A security evaluation system for evaluating securities, the system comprising a system database in which values of a plurality of quality assessment measures and value assessment measures for each company of a group of companies are stored, a user interface for receiving input from a user and providing output to the user, and a processing engine connected to the system database and the user interface, wherein the processing engine is programmed to perform the steps of:
a) computing a value for one or more quality assessment measures for each company of a group of companies;
b) computing a value for one or more value assessment measures for each company of the group;
c) for each quality assessment measure, computing a first mean and a first standard deviation of the values therefor across all companies in the group and computing a relative quality score associated therewith for the company of interest, the relative quality score being a function of the first mean and the first standard deviation;
d) for each value assessment measure, computing a second mean and a second standard deviation of the values therefor across all companies in the group and computing a relative value score associated therewith for the company of interest, the relative value score being a function of the second mean and the second standard deviation;
e) computing a quality composite measure for the company of interest, wherein the quality composite measure is a function of the relative quality scores associated with at least one quality assessment measure;
f) computing a value composite measure for the company of interest, wherein the value composite measure is a function of the relative value scores associated with at least one value assessment measure; and
g) generating output to the user based on the quality and value composite measures for the company of interest, whereby the output reflects a valuation of the company of interest relative to other companies in the group.

22. A computer-readable medium containing instructions for evaluating a security issued by a company of interest to be performed by a computer, wherein the following steps are performed upon execution of the instructions:
a) a value for one or more quality assessment measures for each company of a group of companies is computed;
b) a value for one or more value assessment measures for each company of the group is computed;
c) for each quality assessment measure, a first mean and a first standard deviation of the values therefor across all companies in the group is computed and a relative quality score associated therewith for the company of interest is computed, the relative quality score being a function of the first mean and the first standard deviation;
d) for each value assessment measure, a second mean and a second standard deviation of the values therefor across all companies in the group is computed and a relative value score associated therewith for the company of interest is computed, the relative value score being a function of the second mean and the second standard deviation;
e) a quality composite measure for the company of interest is computed, wherein the quality composite measure is a function of the relative quality scores associated with at least one quality assessment measure;
f) a value composite measure for the company of interest is computed, wherein the value composite measure is a function of the relative value scores associated with at least one value assessment measure; and
g) output to the user based on the quality and value composite measures for the company of interest is generated, whereby the output reflects a valuation of the company of interest relative to other companies in the group.
